(19) United States
(12) Patent Application Publication
(10) Pub. No.: US 2007/0134376 A1
(43) Pub. Date: Jun. 14, 2007

(54) Conversion of organic waste materials, marine plants and animals into a feed and fertilizer powder

(76) Inventor: Larry V. Connell, Yakima, WA (US)

Correspondence Address: STRATTON BALLEW, 213 S 12TH AVE, YAKIMA, WA, 98902, US

(21) Appl. No.: 11/588,829

(22) Filed: Oct. 27, 2006

Related U.S. Application Data
(60) Provisional application No. 60/731,106, filed on Oct. 27, 2005.
(60) Provisional application No. 60/794,065, filed on Apr. 20, 2006.

(51) Int. Cl. A23L 1/31

(52) U.S. Cl. 426/56

(57) ABSTRACT

A process for the conversion of organic materials raw fish waste and other marine plants and animals into a stable powder form, without the use of high heat or cooking. A raw fish waste is initially ground and then hydrolyzed or “enzymatically reduced,” to form a hydrolysate. The hydrolysate is stabilized by adding acid and heated to separate oil and water, to form a product cake. The cake is transferred to a blender for nutrient mixing to form a raw product. The raw product cake is dried in a high velocity air dryer and micronizer. The dryer employs a spiral coil working chamber that preferably circles a separation cyclone. The working chamber can heat the cyclone to conserve energy and provide better drying effect. An alternative of this process eliminates the hydrolysis step and processes finely grinds the raw fish optionally followed by a cold pressing to remove the oil and water, preferably employing bulking agents of other organic nutrients to adjust pH, increase nutrient value, and reduce water and oil concentration.

This application is a Non-Provisional Conversion Application claiming priority to Provisional Patent Application, Ser. No. 60/731,106, filed Oct. 27,2005, and to Provisional Patent Application, Ser. No. 60/794,065, filed Apr. 20, 2006.

### FIELD OF INVENTION

The present invention relates to the conversion of organic waste materials, raw fish waste and other marine plants and animals into a stable powder form, without the use of high heat or “cooking.”

### BACKGROUND

Sixteen elements are known to be essential for ideal genetic expression in plants, and for maximizing plant growth. These elements are generally considered to be: carbon, hydrogen, oxygen, nitrogen, phosphorus, potassium, calcium, magnesium, sulfur, boron, chlorine, copper, iron, manganese, molybdenum, and zinc. The Earth is essentially a closed system, in which these sixteen elements are recycled or moved from one location to another, for example; from the top soil to the ocean, or into the atmosphere. In nature, we observe a precise recycling of these critical elements. When we disrupt the natural cycle, we place our sources of food, fiber, and energy in jeopardy. And so, it is vital for humanity to work in harmony with nature's recycling processes.

Humanity has in some ways short-circuited nature with large scale agricultural practices. Soil, which provides the nutrients required to grow the healthy crops on which we depend, is quickly depleted. In attempts to industrialize and scale-up farming practices, which include the planting of a rapid succession of nutrient sapping crops that cannot replenish the soil, nature's replenishing processes are bypassed. To supplement or supplant nature, farmers must turn to industrial sources to provide fertilizers to keep the soil infused with the sixteen required nutrients and vital organic materials. There is a need to economically produce these essential nutrients in a form readily available for use in a feed or fertilizer, resulting in a more commercially viable animal and plant food.

### BRIEF DESCRIPTION OF DRAWINGS

FIG. 1A is a schematic of a preferred process of the present invention;

FIG. 1B is a schematic of a preferred alternative process of the present invention;

FIG. 2 is a schematic of a preferred alternative in a process of the present invention; and

FIG. 3 is a schematic of a preferred alternative in a process of the present invention.

### DETAILED DESCRIPTION OF PREFERRED EMBODIMENTS

The proper ratios and manipulation of essential nutrients required for ideal plant growth can be facilitated by combining industrial mineral sources with plant and animal materials, to form the ideal ratios and formulations. Previous works of the present inventor, namely found in U.S. Pat. Nos. 6,461,399 and 5,466,273, detail processes for converting manures and farm waste into fertilizer products. A desired result of these conversions is a more commercially viable animal and plant food. The process of the present invention converts raw fish waste, and other marine plants and animals, into a product preferably having a stable powdered form, without the use of high heat or cooking. Additional organic materials may be added to stabilize or otherwise augment the above product.

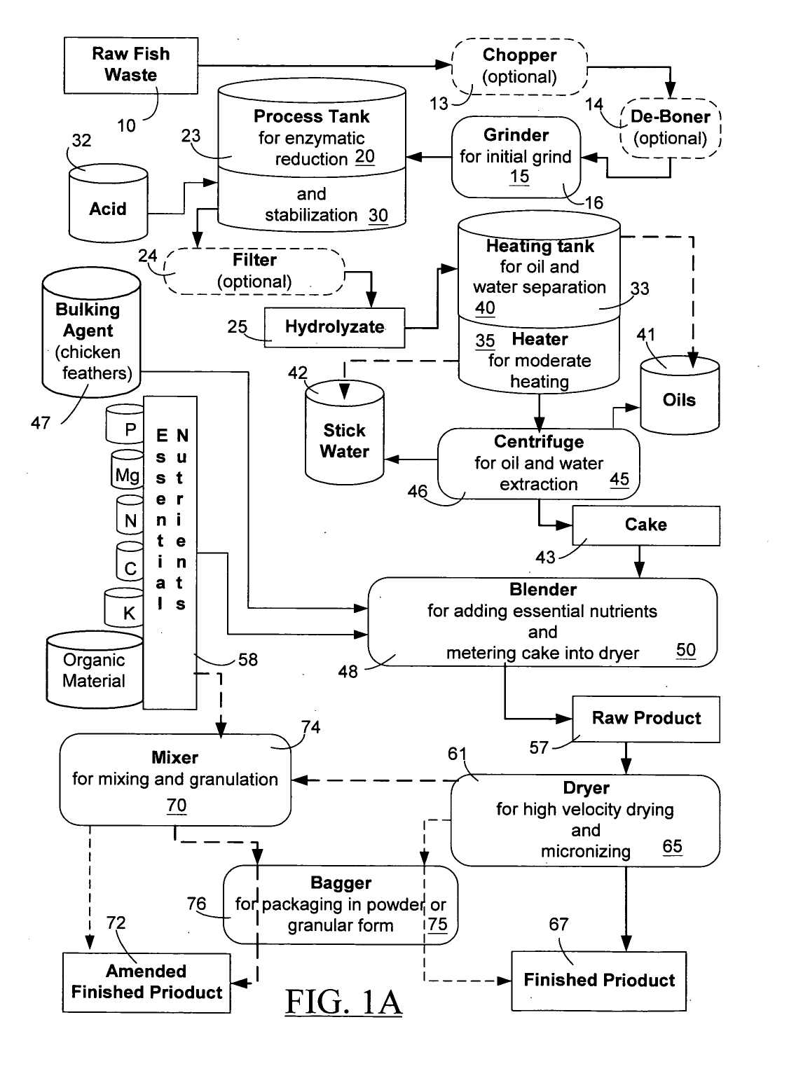

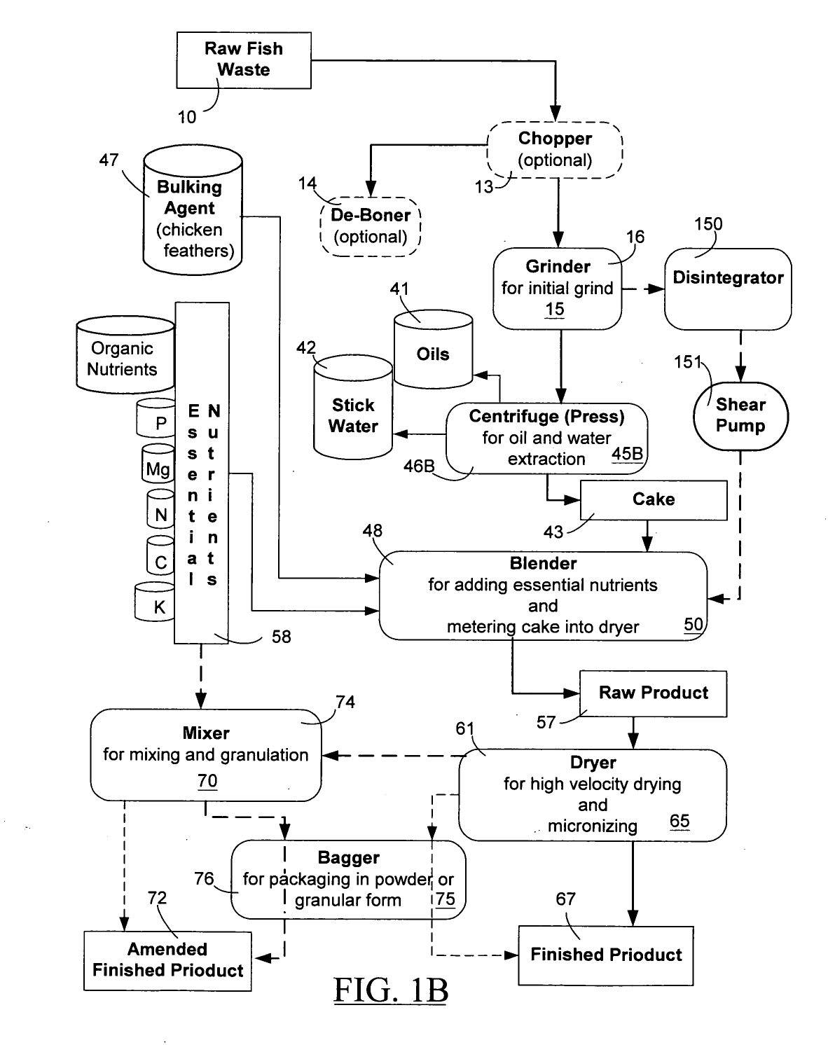

Preferred embodiments of the process of the present invention are schematically shown in FIGS. 1A through 3. As shown in FIG. 1A, a raw fish waste 10 is initially ground 15 in a grinder 16, and then hydrolyzed or “enzymatically reduced” 20, within a process tank 23. This hydrolyzation is achieved by enzyme additives self-contained, enzyme reactions within the raw fish waste, to form a hydrolysate 25.

To manufacture animal feeds, one would use a variation on the above procedure, and include the initial separation of bone from the tissues in the initial grind 15 of the raw fish waste 10. As shown in FIG. 1A, with dashed elements to denote optional procedures or process equipment, this variation is accomplished through gentle stirring and separation of tissue and skeleton of the fish waste, preferably followed by screening with a conventional screen, filter, or most preferably by use of a de-boner 14, to maximize the protein and minimize the calcium and phosphorous being separated, which in-turn decreases the ash content. A chopper 13 may also be employed, preferably upstream of the de-boner, to aid in separating the bones prior to grinding.

Within the process tank 23, the enzymatic reduction or hydrolyzation 20 is followed by a stabilization 30, through the addition of an acid 32, the acid employed in this biological stabilization may be any appropriate acid employed in feed and fertilizer formulation, most preferably a sulfuric acid, a phosphoric acid, a humic acid or a citric acid. The acid is employed to lower the pH of the fish hydrolysate. Most preferably, the pH is not lowered below a pH value of 3.5.

The hydrolysate 25 is then transferred to a heating tank 33, where it undergoes a moderate heating 35. This moderate heating step is preferably a gentle heating of the hydrolysate to approximately 120 to 150 degrees Fahrenheit (to 65.5 degrees Celsius) to achieve an oil and water separation 40, without boiling the solution. The term “approximately” is used herein to refer to a range of values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produces equivalent results to those described herein. The oil and water separation within the heating tank may include a decanting of any oils 41 collecting at the top of the heating tank and any waters 42 separating from the hydrolysate, typically as a distinct layer below the oils. This separation is best achieved by minimizing stirring or agitation of the hydrolysate within the heating tank. The moderate heating is followed by injecting the heated substrate into a centrifuge 46.

Specifically, in this three-phase separation within the centrifuge 46, the oils 41 and waters 42 are both separated from a product cake 43, which is simply referred to herein as a “cake.” The centrifuge is preferably a conventional, three-phase, horizontal decanting centrifuge, as is well known to persons skilled in industrial separation technologies. For example, Earth Technologies, Inc., of Longemont, Colo., USA, has developed a long radius arm, “ERTH®” brand centrifuge that should be able to efficiently separate these different waste streams. The waters 42 are generally referred to herein as “stick water,” which is conventionally a tea colored, often brackish and nutrient rich liquid, ideal for use as a sprayed soil amendment. The centrifuge provides for the extraction of the oils and waters 45, with the extracted oils separate from the stick water, and furthermore retains the cake for additional processing.

An alternative to, or in addition to the preferred use of the centrifuge 46. The oil concentration within the hydrolysate 25 can be diluted by addition of other waste streams to absorb the excess oils. For example, a bulking agent 47 may be blended into the hydrolysate. A most preferred bulking agent is chicken feathers, preferably pulverized or otherwise comminuted into a pulp or finely shredded consistency. Chicken feather are an ideal bulking agent in that they have a high pH and readily absorb oils, while adding solids to the hydrolysate mixture. Other slaughter wastes from poultry, hogs or cattle could also be utilized, to provides increased nutrient levels, pH control and slow nitrogen release qualities. With the high pH of the chicken feathers, base additives are minimized or not required, as would be needed to neutralize the cake from the prior addition of the acid 32.

The cake 43 is the residual substrate or of the fish hydrolysate 25, after the oils 41 and stick water 42 are extracted. From the centrifuge 46, the cake is transferred to a blender 48. A primary purpose of the blender is for a nutrient mixing 50 into the cake to form a raw product 55. Specifically, the nutrient mixing includes the blending of an essential nutrient 58 into the cake. The essential nutrient can include any material that serves in some way to add to or supplement the cake with the nutrients generally recognized as essential, or other attributes needed for ideal plant and animal growth, such as pH adjustment, buffering, or balancing.

The raw product 57, which is essentially the cake 43 as amended with the essential nutrients 58 and now substantially dewatered and oil free, is ready to be dried and micronized 60, The dryer is preferably a high velocity air dryer and micronizer. Most preferably, the blender is employed to meter the raw product into the dryer 55. The high velocity air dryer and micronizer are employed for particle size reduction, mixing and drying of the raw product, converting it into a finished product 67.

In an optional alternative of the present process, if the essential nutrient 58 additives are in a soluble powder form, they may be blended 70 into the finished product 67 following the drying 61 and micronizing 62 of the raw product, to form an amended finished product 72. A mixer 74 is preferably employed to perform this blending. As preferred, the mixer may also granulate 75 the amended finished product. The finished product 67, or the amended finished product 72 is ready for distribution and use in feed or fertilizer activities. A bagging 75 of the products in either powder or granular form is preferably performed to better manage the bulk product.

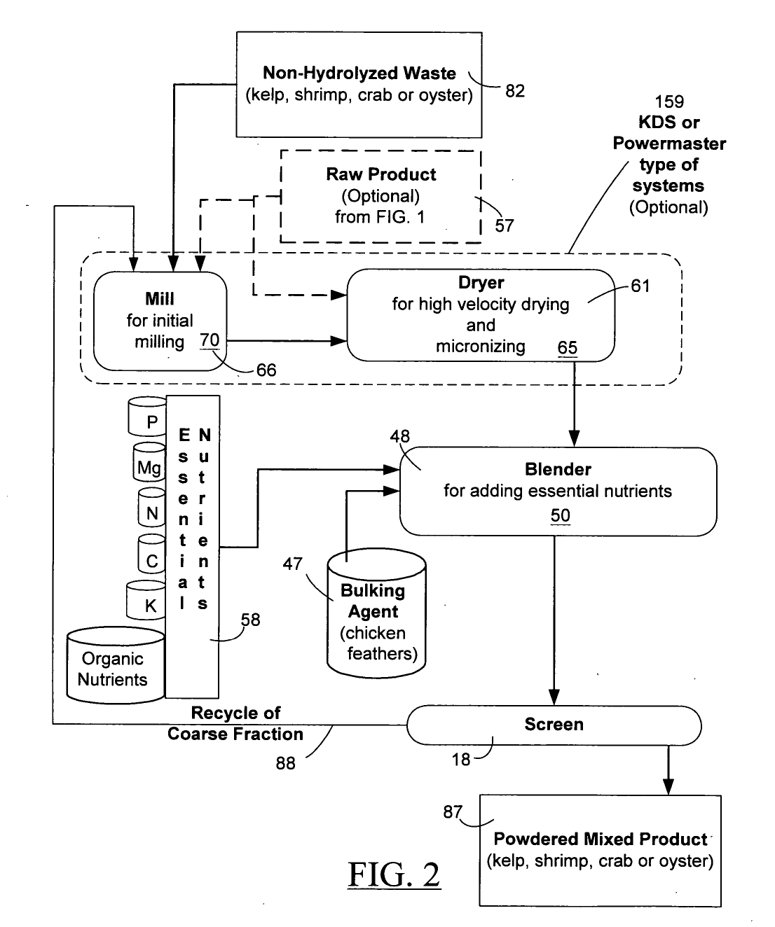

In an additional alternative embodiment of the present process, as detailed in FIG. 2, certain marine plants and animals such as crab, oyster, kelp and shrimp, which are a raw fish waste 10 all referred to herein as non-hydrolyzed waste 82, may be ground to a size that allows direct entry into the dryer 61, uniquely configured for high air velocity drying and micronizing 65, without any prior enzymatic hydrolysis and acid preparation. A mill 66, such as the model “1101GH” of the AUTIO brand of grinder, as manufactured by the Autio Company, of Astoria Oreg., USA, or alternatively, a comparable “Fitz” or Fitzpatrick brand of mill, discussed later herein, can be employed for an initial milling of the non-hydrolyzed waste. These powder forms of marine plant and animal waste can be blended with the fish hydrolysate formed by the process shown in FIG. 1A, and preferably in the form of the raw product 57. This blending provides the desired nutrient levels in a powdered mixed product 87, or the essential nutrients 58 may be added and blended 50 in the blender 48.

From the blender 48, the non-hydrolyzed waste 82 can be introduced into a screen 18 to obtain a uniformly grained powdered mixed product 87. Again, the essential nutrients 58 introduced into the blender can include acids and various other nutrients, from the known roster of essential elements, to form complete nutrient quantities and ratios for distribution into the feed and fertilizer markets. As indicated in the coarse fraction recycle 88 from the screen, as shown in FIG. 2, some hard-shelled marine animals my need two passes through the mill 66, and the high air velocity micronizing 65 of the dryer 61, to obtain adequately small particle size.

As shown in FIG. 1B, in an alternative embodiment of the present invention, especially useful when processing certain raw fish wastes 10 that are reasonably well homogenized, either from prior chopping 13 and de-boneing 14, or as found with certain raw fish waste, the raw fish wastes do not require treatment in the process tank 23 for enzymatic reduction 20 and stabilization 30, as previously discussed herein, and shown in FIG. 1A.

The alternative process of FIG. 1B eliminates the step of enzymatic reduction 20 and instead the raw fish 10 by grinding 15 and preferably an oil 41 and “stick” water 42 pressing in a press 45B, rather than the alterative centrifuge 45, to extract the oil and water 46B. This alternative process preferably employs the bulking agent 47, as discussed above, to adjust pH, increase nutrient value, and reduce water and oil concentration. Again, a preferred bulking agent is found to be chicken feathers. The raw product 57 is then dried using a disintegrator 150, such as the model M12A manufactured by CORNECO™, Inc., of Sebasopol Calif., USA. The disintegrator may be used alone, or in combination with a KDS Micronex™system, as manufactured by First American Scientific Corporation of Las Vegas, Nev., USA. The use of a KDS or Powermaster type of system can greatly reduce or eliminate the need for the dryer 61, as shown in FIG. 2. The blender 48 can then be used, to add essential nutrients 58, such as additional organic material. The finished product 67 is a fine mesh, dry powder useful as a fertilizer or feed.

A alternative preferred process of the present invention, essentially as shown in FIG. 2, may additionally include a micronizing CORENCO brand disintegator 150, discussed above, as the mill 66 for the initial milling 70. The disintegrator act as the mill and feed the milled non-hydrolyzed waste 82 into the dryer 61. As shown in FIG. 1B, the disintegrator may used with a shear pump 151, such as “Boston Shearpump” brand of pumps, as manufactured by Admix of Manchester N.H., USA.51

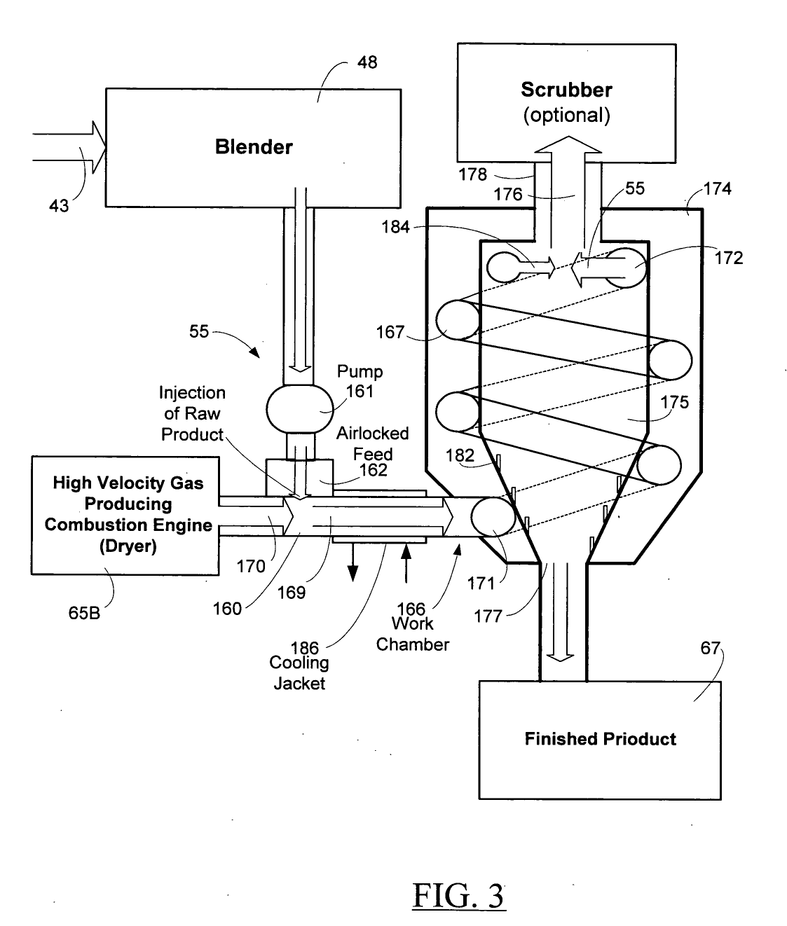

A most preferred alternative configuration of the dryer 61B is shown in FIG. 3, and includes a unique acceleration tube 160 that routes a dried raw product 164 exiting from the dryer into a work chamber 166. A preferred dryer employed with the acceleration tube and work chamber is a high velocity gas producing combustion engine 61B. The preferred dryer may be a standard “roots” type of positive displacement blower, or more preferably a standard “pulse” type of engine, which generates the high velocity gas required for the acceleration tube 160.

The preferred dryer 61B generates a dryer exhaust stream 170 that receives a stream of product particles 169. An injection pump 161 operates in conjunction with an airlocked feed 162, to meter the cake into the dryer 55, as shown in FIG. 3. The airlocked feed may be any conventional device that prevents the back flow of the dryer exhaust stream and stream of product particles 169. Preferably, a pair of gates are utilized, to alternately open and close, timed with operation of the injection pump. Paddles, augers and geared inlets of conventional design are also considered for use. The work chamber 166 preferably employed for the system of the present invention includes a spiral coil tube 167, as shown in FIG. 3, that requires the stream of product particles 169 to constantly strike curved surfaces of the spiral coil tube as it makes its high speed journey from an inlet end 171, to a distal end 172 of the work chamber's spiral coil tube.

The work chamber 166 may also include a separation cyclone 175 to segregate the dried raw product 164 into the finished product 67 and an exhaust stream 176. The finished product 67 is particulate material that exits the separation cyclone at a bottom outlet 177, and the vapor exhaust stream exits from the separation cyclone at a top outlet 178. The spiral coil tube may be wrapped with a sound and heat insulation 174, and preferably around a separation cyclone 40, to conserve space and heat, while suppressing noise. The working chamber can heat the cyclone to conserve energy and provide a superior drying effect, when compared to conventional drying systems.

The high velocity drying and micronizing 65 within the dryer 61 and the work chamber 166 may also employ a collision obstacle 182, such as active baffles, blades, chains, and various other such well known types of barriers, to accomplish the desired process work. Examples of such collision obstacles are found in KDS Micronex™ system, discussed herein above, and the Powermaster Model “M,” manufactured by Karl W. Schmidt and Associates of Commerce City, Colo. As an alternative, the work chamber may be provided with a supplemental compressed air feed 184, to best accomplish the desired drying and micronizing.

Also, an additional alterative of the present invention the separation cyclone 175 may include a conical fan within. The conical fan is preferably equipped with pulverizing rods, spaced along the interior of the cone shaped shell. An auxiliary engine could be utilized to drive the conical fan within the cone shaped shell of the separation cyclone.

As discussed above, located proximate to the distal end 172 or terminal end of the work chamber 166, the separation cyclone 175 is utilized to remove the finished product 67 in its particulate form. The separation cyclone may be a conventional device well known to those skilled in industrial material separation technologies. The separation cyclone directs an exhaust stream 179 upward. The exhaust stream primarily includes heated water vapor, or steam. The dried, particulate finished product circulates centrifugally and falls downward within the separation cyclone, exiting through the bottom outlet 177, by operation of gravity and the cyclonic separation.

For use with the present invention, each raw fish waste 10 utilized as a source material, will have a specialized and optimal configuration matrix of: dryer 61 geometry and energy source pairing; acceleration tube 160 configuration and work chamber 166 design; and separation cyclone 175 selection. For example, decreasing the diameter of the spiral coil tube 167 will compress the air stream of product particles 169, and increase air velocity and temperature within the work chamber. Increasing the diameter of the spiral coil tube will slow the air stream containing the product particles, and cool the temperature within the work chamber. This is useful when choosing a air source whether it is compressed air from a “roots” type of compressor, or exhaust air generated from a “pulse” type of engine. This optimal matrix is most preferably selected to meet the raw fish waste 10 or equivalent source material's specific drying and particle size reduction needs, and economic realities.

Waste heat created by the drier 61, or the high velocity gas producing combustion engine 61B may also be employed to pasteurize the stick water 42 or any other heating, process or co-located need. A cooling jacket 186 may be included surrounding the acceleration tube 160 and optionally, the work chamber 166 to heat this waste water stream and remove heat from the dryer, thereby serving as a cooling system.

### EXAMPLE 1

Raw fish waste 10 can include fresh, whole or waste fish and related fishing wastes, which are a byproduct of fishing operations and processing of wild and farm fish, and additionally from operations, such as the processing of crab, krill, shrimp, sea weed and kelp; all provide an excellent feed stock source for the manufacture of plant and animal food. As shown in FIG. 1, the entirety of the raw fish waste, including all fleshy and bony parts, is pre-processed by manually or mechanically chopping it into preferably one to two cm diameter chunks, in a chopper 13, and then de-boning the raw fish waste in a de-boner 14. The de-boner is most perferably a pressure de-boner, as is well known in fish de-boning technologies. The chopper and de-boner are optional, in that certain fish wastes do not require bone removal. The optional pre-processing chopping and de-boning may already have been accomplished in the processing that first utilized the fish material, such as canning or packing operations. After the optional chopping and de-boning operations, the raw fish waste is pre-ground 11 in the initial grind 15. Again, for precise particle size reduction, the initial grind is preferably achieved with a conventional 1101GH model of AUTIO brand of grinder which includes a high speed pulverizing head, alternatively, a FitzMill® communitor, as manufactured by Fitzpatrick of Elmhurst, Ill., USA, or alternatively a Silverson mixer-homogenizer, as manufactured by Silverson Machines LTD., of Chesham Bucks, U.K, could be utillized. Again, the initial grind promotes tissue disintegration of the raw fish waste, and facilitates the release of natural enzymes present within the fish waste. These natural enzymes break down fish proteins into their simpler amino acid forms, releasing the oils 41 and water 42.

The acid 32, added to the process tank 23, is most preferably sulfuric, phosphoric, humic or acetic acid, each added as needed to provide stabilization through pH reduction, down to approximately 3.5 pH. A combination of acids may be employed, which may be useful to provide essential nutrients 58 to the hydrolysate 25. The resulting fish hydrolysate is excellent for use the manufacture of certified organic fertilizers, as formed in the finished product 67.

Additionally, after treatment in the process tank 23, the filter 24 may be used to remove any bone material 22 still present in the hydrolysate 25. This option is preferred, especially if the raw fish waste 10 includes bony fish, and is most preferably use with the optional chopper 13 and de-boner 14, discussed above.

### EXAMPLE 2

In a proposed embodiment of the present invention, a typical hydrolysate 25, approximately 15% oil, 60% water, and 25% solids, could be formed from typical raw fish waste 10, depending on fish type and stage of fish development. After the enzymatic reduction 20 and stabilization 30 in the process tank 23, the hydrolysate could then be transferred to the heating tank 33, where it is heated to a moderate non-protein denaturing temperature of approximately 140 degrees F. (60 degrees C.) to facilitate the separation 40 of the oil 41 and water 42 from the hydrolysate solids. The oil, water and hydrolysate solids are extracted 45 with the three phase horizontal decanting centrifuge 46. The hydrolysate solids are then transferred to a specially designed blender 48, for addition of essential nutrients 58 and introduction into the high velocity air micronizer and dryer 61.

After the oil and water extraction 45 of the centrifuge 46, the cake 42 or fish hydrolysate solid, still would contain approximately 60% water, by weight. At this stage of the process, the cake exhibits a consistency similar to wet clay. If desired, the cake is then mixed or supplemented with essential nutrients 58, to form the raw product 57, and is then processed by the dryer 61 for high velocity air dryer and micronizing 65. This process step preferably includes a metering of the raw product into the dryer 55 through a specially designed injector, prior to entry into the acceleration tube 160. The acceleration tube consists of a pipe with a diameter of approximately four inches to six inches (ten centimeters to fifteen centimeters), and a length of approximately ten feet to thirty feet (three meters to nine meters), through which is flowing a high velocity air stream or the dryer exhaust stream 170. The acceleration tube is preferably made of stainless steel or a high density plastic, or alternatively a steel pipe that is most preferably glass lined to reduce friction. The hydrolysate solids of the cake are preferably accelerated in the dryer exhaust stream to an approximate velocity of over 450 miles per hour (725 kilometers per hour), or approximately 40,000 feet per minute (12,000 meters per minute), before entering a communtion chamber within the dryer. Alternatively, a multiple of chambers may be employed. The hydrolysate admixture is at this time subject to physical forces that affect the ability of the water, because of the different densities of water and organic matter of the hydrolysate, to remain physically and chemically bound to each other. The air speed, along with the acceleration tube diameter and configuration, and the pressure. Additionally, the internal communtion chamber air stream obstacles, or lack of them, and proper venting of the water-organic matter separation chamber, all play a critical roll in the effectiveness of the micro-aerosol water and organic matter separation. The particle disintegration that also occurs during the high velocity impaction inside the communtion chamber allows the separation of free water, and bound water. Typical air velocities necessary to accomplish this drying and particles size reduction should be in the approximate range of 40,000 feet per minute (12,200 meters per minute). This is subsonic velocity is developed with system static pressure as high as approximately 15 psig (103 kPa).

### EXAMPLE 3

In a proposed embodiment of the present invention, the dryer 61B for high velocity air dryer and micronizing 65, can be a pulse detonation engine, or “PDE,” which has been found to generate air velocities up to approximately 4,000 feet per second (1,200 meters per second). Such an engine is a suitable choice for air source for the high velocity air dryer and micronizing process, described above, when the engine is operated at the appropriate high velocities. This high velocity can be achieved by increasing the diameter of the acceleration tube 160. The stabilization 30 of the raw fish would be further enhanced by the high speed thrashing after treatment at the approximate 140 degree F. (60 degree C.) temperature required for oil and water separation, and after the addition of acid 32 to achieve an approximate pH of 3.5 pH. The placement of the injection point of the metered cake into the dryer 55 at the orifice of the four-inch (ten centimeter) accelerator tube is likely important to cause even distribution of the hydrolysate into the acceleration chamber. Again, velocities between approximately 40,000 and 45,000 feet per minute (12,200 meters per minute and 13,700 meters per minute) are critical to produce the desired results when processing marine plant and animals.

By addition of stabilizers into the hydrolysate 25, and the use of a non-thermal method of processing and drying, as described above, important organic molecular configurations could be preserved. For example, in fish, the naturally occurring omega-3 and omega-6 fatty acids can be preserved during this low-heat manufacturing process. This benefit adds considerable value to the marketing of the end product. Proper ratios and manipulation of the sixteen essential nutrients required for ideal plant growth can be facilitated by combining outside mineral sources and different amounts of plant and animal species powder to form ideal ratios as described in U.S. Pat. Nos. 6,461,399 and 5,466,273.

### EXAMPLE 4

In a proposed embodiment of the present invention, a raw fish waste 10 containing 70% water by weight, could be chopped 13 and initially ground 15, then centrifuged 46 and metered 55 into the dryer 61. This metered introduction into the dryer may be supplemented with a pressurized injection, preferably employing an auger or similar forcing mechanism. The dryer could be a pulse type of engine. It is predicted that this source material would pass through the system with a final result of 12% moisture by weight. The 27 cubic inch or about 0.015 cubic foot pulse engine should run at about 750 firings/min to produce 11 cu ft of hot, high speed air/min to produce around 300 psi of impact force. The fertilizer source material is fed into the acceleration tube and processed through the work chamber in the form of the spiral coil tube, of about 30 feet of a 1.25 inch pipe. Preferably, the spiral would be approximately one foot on up to approximately 3 feet in diameter. The pipe is preferably insulated and the dried raw product 164 contents empty into a conventional 15 cu ft separation cyclone 40, for separation of the water from within the cone environment. As expected, there would be considerable movement of the particles in the separation cyclone due to a restriction of the incoming air at the point of entry so as to increase the speed of the entering gas. This restriction causes a back pressure of about 9 psig on the pulse engine, without any anticipated problems on its ftunction. This restriction also increased dwell time of the raw feedstock while traveling down the spiral coil tube acceleration. Small quantities steam might be observable with a typical ambient temperature of around 70 degrees F., and the moisture of the exhaust stream 176 from the top outlet 178, should be approximately 110 degrees F. The finished product 67 should measure approximately 12% moisture by weight, out the bottom outlet 177 of the separation cyclone 175.

### EXAMPLE 5

In actual pilot runs of different potential raw fish wastes 10 for use with the processes of the present invention, a 1:1 mixture of fish waste and discarded wheat, as an organic material essential nutrient 58 referred to in Table 1, below as Fish/Wheat; a blended mix of fish bones referred to in Table 1, below as FishBones; a mix of discarded crab processing waste referred to in Table 1, below as Crab; a mix of fish bone meal processing waste referred to in Table 1, below as BoneMeal; and a mix of discarded fish and crab processing waste referred to in Table 1, below as Fish/Crab, were each individually processed employing the system essentially as schematically shown in FIG. 2. All of these products were under 100 standard mesh, with phosphate analyzed as P₂O₂, potassium as K₂O, and other than pH, all values are reported as weight percent to weight of total finished product 67. The following results were obtained:

TABLE 1

| | | | Potas- | | | |
|---|---|---|---|---|---|---|
| | Nitrogen | Phosphate | sium | Calcium | pH | Moisture |
| Fish/Wheat | 4.6 | 3.5 | 0.4 | — | 6.5 | 10 |
| FishBones | 6.03 | 3.7 | 0.6 | 3.9 | 7.8 | 5 |
| Crab | 5.9 | 4.2 | 0.6 | 3.2 | 7.6 | 12 |
| BoneMeal | 10.2 | 4.1 | 1.5 | — | 5.9 | 15 |
| Fish/Crab | 6.7 | 4.4 | 0.7 | — | 7.2 | 10 |

Having now described my invention, to those skilled in the art to which it pertains, it may become apparent that the need to make modifications without deviating from the intention of the design as defined by the appended claims.

What is claimed is:

1. A process for conversion of marine plants and animals into a feed and fertilizer powder comprising the steps of:
a) grinding a raw fish waste in a grinder;
b) enzymatically hydrolyzing the raw fish waste to form a hydrolysate;
c) stabilizing the hydrolysate through the addition of an acid to lower the pH of the fish hydrolysate;
d) heating the hydrolysate to achieve an oil and a water separation;
e) decanting any oils collecting at the top of the heating tank and any waters separating from the hydrolysate;
f) separating the oils and waters within a centrifuge to form a product cake;
g) mixing a nutrient into the cake to form a raw product;
h) drying the raw product with a high velocity air dryer;
i) routing a dryer exhaust stream containing a stream of product particles through a working chamber prior to entry into a separation cyclone, the working chamber wrapped around the cyclone in a spiral form; and
j) micronizing the raw product within the working chamber to form a finished product.

2. The process of claim 1 additionally comprising the step of:
k) pre-heating the separation cyclone with heat from the dryer exhaust stream.

3. A process for conversion of marine plants and animals into a feed and fertilizer powder comprising the steps of:
a) grinding a raw fish waste in a without enzymatic hydrolization to form a ground raw fish waste;
b) heating the ground raw fish waste to achieve an oil and a water separation;
c) mixing a nutrient into the cake to form a raw product;
d) drying the raw product with a high velocity air dryer;
e) routing a dryer exhaust stream containing a stream of product particles through a working chamber prior to entry into a separation cyclone, the working chamber wrapped around the cyclone in a spiral form; and
f) micronizing the raw product within the working chamber to form a finished product.

4. The process of claim 3 additionally comprising the step of:
g) pre-heating the separation cyclone with heat from the dryer exhaust stream.

5. The process of claim 3 additionally comprising the steps of:
g) decanting any oils collecting at the top of the heating tank and any waters separating from the ground raw fish waste; and
h) separating the oils and waters within a centrifuge to form a product cake.
